(19) United States
(12) Patent Application Publication
(10) Pub. No.: US 2013/0232881 A1
(43) Pub. Date: Sep. 12, 2013

(54) GLASS RUN

(71) Applicant: TOYODA GOSEI CO., LTD., Kiyosu-shi (JP)

(72) Inventors: Kentaro ADACHI, Kiyosu-shi (JP); Yoshihiro MIURA, Kiyosu-shi (JP)

(73) Assignee: TOYODA GOSEI CO., LTD., Kiyosu-shi (JP)

(21) Appl. No.: 13/788,380

(22) Filed: Mar. 7, 2013

(30) Foreign Application Priority Data
Mar. 9, 2012 (JP) 2012-052685

(51) Int. Cl. B60J 10/00

(52) U.S. Cl. CPC B60J 10/0025
USPC 49/490.1

(57) ABSTRACT

A glass run for use in a sashless door-type motor vehicle, which is capable of being readily produced and securely attached without coming off a door frame, etc. The glass run includes an upper side portion, a front vertical side portion, a rear vertical side portion, a front corner portion and a rear corner portion. In the upper side portion, a glass run section and a trim section are integrally formed. A corner joining section of the corner portion extends from the upper side portion such that at least one part of the glass run section and an inner seal lip of the trim section are cut off, an inner seal lip is formed in an area corresponding to the cut inner seal lip by molding so as to be gradually tapered towards an end thereof, and an engaging protrusion adapted to be engaged with an end of the door frame is provided near an end of a corner engaging section.

### CROSS-REFERENCE TO RELATED APPLICATION

This application is related to and claims priority from Japanese patent Application No. 2012-052685 incorporated herein by reference.

### BACKGROUND OF THE INVENTION

1. Field of the Invention

The present invention relates to a glass run adapted to be attached to a door frame of a motor vehicle for providing a seal between a door opening portion and a vehicle door.

2. Description of Related Art

In order to effect a seal between a door opening portion and a vehicle door having a door sash, in one example of conventional seal structures, an opening trim weather strip is attached to a flange provided in the door opening portion, and a door weather strip is attached to an outer periphery of the door sash. When the vehicle door is closed, a tubular seal portion of the opening trim weather strip contacts a protrusion of the door sash, and a tubular seal portion and a seal lip of the door weather strip contact an outer panel of the door opening portion to seal a gap between the door opening portion and the vehicle door.

And a door glass provided in an interior of the vehicle door is held with a glass run of which an outer periphery thereof is attached along an inner periphery of the door sash, and is raised and lowered in a groove of the glass run, which has a generally U-shaped cross-section. This glass run effects a seal between the door glass and the door sash.

In side surfaces of the motor vehicle, the glass run, the door sash, and a center pillar are exposed around the door glass so that it has been required to improve the design thereof. In addition, glass runs exist between the door sash and the door glass, and between the center pillar and the door glass so as to define a gap between the door sash and the door glass, which is less preferable in design.

In order to overcome the above-described problem, as shown in FIG. 1, in a sashless door-type vehicle body, an exterior part of a door sash is removed except for a flange so as to freely raise and lower a door glass 10 above the door belt line of a vehicle door 12. With this arrangement, in the side surface of the motor vehicle, only the door glass 10 is visible above the door belt line of the vehicle door 12.

In this case, as shown in FIG. 2, a glass run 14 includes a glass run section 16 adapted to effect a seal between the door glass 10 and a door frame 18, and a trim section 20 adapted to attach the glass run 14 to a flange 22 extending along an end edge of the door frame 18 (see Japanese patent application laid-open No. 2002-46476, for example). The glass run section 16 has a main body with a generally U-shaped cross-section, which includes an outer side wall 24, an inner side wall 26 and a bottom wall 28. An outer seal lip 30 and an inner seal lip 32 respectively extend from ends of the outer side wall 24 and the inner side wall 26 obliquely in an interior space of the main body. The outer seal lip 30 and the inner seal lip 32 effect a seal against the door glass 10.

The trim section 20 has a generally U-shaped cross-section, and includes a side wall 34 formed integrally with the bottom wall 28 of the glass run section 16, a side wall 36 formed on the side of a vehicle body, and a bottom wall 38. An outer seal lip 40 and an inner seal lip 42 are formed in an exterior surface of the side wall 36 for contacting and sealing a door opening portion 44 when the vehicle door 12 is closed.

And, as shown in FIG. 3, in order to improve the appearance of the door frame 18, in a corner part 46 of a glass run 48, an outer side wall 50 along with a bottom wall 52 of a trim section 54 are extended in an extension direction of an upper side portion 56 (see Japanese patent application laid-open No. 2010-18130, for example).

In this case, in order to join the upper side portion 56 to a rear vertical side portion 58, it has been required to cut an end of a side wall 60 on the side of a vehicle body along with an inner seal lip 62 of the trim section 54 except for an outer seal lip 64 of the trim section 54, and then form the inner seal lip 62 upon molding the corner part 46.

However, when the corner part 46 thus molded is removed from the mold, there may occur the problem that the molded inner seal lip 62 of the trim section 54 is caught in the mold so that it becomes difficult to remove the corner part 46 from the mold.

In addition, since the corner part 46 is formed by molding, it is difficult to use a hard material for the corner part 46, thereby degrading the rigidity thereof, and therefore, it has been required to prevent the glass run 48 from coming off the door frame 18 and a garnish secured thereto.

### SUMMARY OF THE INVENTION

It is an object of the present invention to provide a glass run for use in a sashless door-type motor vehicle, which can be readily produced and securely attached without coming off a door frame, etc.

In order to achieve the above-described object, according to a first aspect of the present invention, in a glass run adapted to be attached to a door frame of a vehicle door for providing a seal between a door opening portion and the vehicle door, the glass run has an upper side portion formed by extrusion and adapted to be attached to an upper side of the door frame, a vertical side portion formed by extrusion and adapted to be attached to a vertical side of the door frame, and a corner portion formed by molding to join the upper side portion and the vertical side portion to each other, and adapted to be attached to a corner of the door frame.

The upper side portion includes a glass run section adapted to seal a door glass, and a trim section adapted to be attached to the door frame, which are integrally formed with each other.

The glass run section includes an outer side wall, an inner side wall and a bottom wall with a generally U-shaped cross-section, and an outer seal lip and an inner seal lip respectively extend from ends of the outer side wall and the inner side wall obliquely in an interior space of the glass run section with a generally U-shaped cross-section.

The trim section includes one side wall located on the side of the glass run section, the other side wall located on the side of a vehicle body, and a bottom wall with a generally U-shaped cross-section, and an outer seal lip and an inner seal lip are formed in the other side wall located on the side of the vehicle body for contacting a door opening portion.

The corner portion includes a corner joining section adapted to join the upper side portion to the vertical side portion, and a corner engaging section extending from the corner joining section for engagement with the door frame. The corner joining section extends from the upper side portion such that at least one part of the glass run section is cut off along with the inner seal lip of the trim section, an inner seal lip is formed in an area corresponding to the cut inner seal lip by molding so as to be gradually tapered towards an end thereof, and an engaging protrusion adapted to be engaged with an end of the door frame is provided near an end of the corner engaging section.

With the arrangement of the first aspect of the present invention, the upper side portion includes a glass run section adapted to seal a door glass, and a trim section adapted to be attached to the door frame, which are integrally formed with each other. Therefore, the glass run section and the trim section can be simultaneously obtained by extrusion, thereby facilitating the production thereof. In addition, the entire dimensions of the glass run section and the trim section can be decreased, thereby making the arrangement around the upper side of the vehicle door simple, whereby the external appearance can be improved.

The glass run section includes an outer side wall, an inner side wall and a bottom wall with a generally U-shaped cross-section, and an outer seal lip and an inner seal lip respectively extend from ends of the outer side wall and the inner side wall obliquely in an interior space of the glass run section with a generally U-shaped cross-section. As a result, the glass run section can guide the raising and the lowering of the door glass, and the outer seal lip and the inner seal lip can hold the door glass, and seal a periphery thereof.

The trim section includes a side wall located on the side of the glass run section, a side wall located on the side of a vehicle body, and a bottom wall with a generally U-shaped cross-section, and an outer seal lip and an inner seal lip are formed in the side wall located on the side of the vehicle body for contacting the door opening portion. As a result, the glass run can be attached while holding an end of the door frame with the side walls and the bottom wall of the trim section, whereby when the door glass is raised or lowered, the glass run section can securely seal the door glass.

When the vehicle door is closed, the outer seal lip and the inner seal lip of the trim section contact the door opening portion to effect a seal between the vehicle door and the door opening portion.

The corner portion includes a corner joining section adapted to join the upper side portion to the vertical side portion, and a corner engaging section extending from the corner joining section for engagement with the door frame. Therefore, upon molding the corner portion, the upper side portion and the vertical side portion can be bonded through vulcanization in the corner joining section. In addition, the corner engaging section can attach the corner portion to the door frame, thereby preventing the corner portion from coming off the door frame.

The corner joining section is extended from the upper side portion, and is formed such that at least one part of the glass run section and the inner seal lip of the trim section are cut off. Therefore, the bottom wall of the trim section and the outer side wall of the glass run section, which are extended from the upper side portion, can be integrally extended to an end of the upper side of the corner portion, whereby the appearance of the corner portion can be improved to its end, and the corner joining section can join the upper side portion and the vertical side portion, each having a different cross-sectional shape.

An inner seal lip is formed in an area corresponding to the cut inner seal lip of the trim section by molding so as to be gradually tapered towards an end thereof. Therefore, after molding the corner portion, the inner seal lip of the corner portion can be readily removed from the mold while maintaining sealing properties of the corner portion.

Since the engaging protrusion adapted to be engaged with an end of the door frame is provided near an end of the corner engaging section, an end of the door frame or a garnish attached to the door frame can be engaged with the engaging protrusion, thereby preventing the corner portion of the glass run from coming off the corner of the door frame, and ensuring sealing properties thereof.

According to a second aspect of the present invention, the engaging protrusion is engaged with an end of a garnish attached to the vertical side of the door frame.

Since the engaging protrusion is engaged with the end of the garnish attached to the vertical side of the door frame, the vertical side of the door frame can be covered with the garnish, and a gap between the garnish and the glass run can be decreased, whereby the corner portion of the glass run can be securely engaged with the corner of the door frame.

According to a third aspect of the present invention, the corner engaging section extends from the upper side portion such that the inner side wall, the bottom wall and the inner seal lip of the glass run section are cut off along with a half of the side wall of the trim section, which is located on the side of the vehicle body, and the inner seal lip of the trim section.

Since the corner engaging section extends from the upper side portion such that the inner side wall, the bottom wall and the inner seal lip of the glass run section are cut off, the dimensions of the corner engaging section can be decreased, thereby facilitating the attachment to the end of the door frame and enabling the formation of the engaging protrusion in the corner engaging section by molding, and since the glass run of the rear vertical side portion and the glass run section of the upper side portion are bonded to each other, the corner portion can be formed such that the configuration of the glass run is gradually changed therein.

Since the half of the side wall of the trim section, which is located on the side of the vehicle body, and the inner seal lip of the trim section are cut off, the dimensions of the trim section in the corner portion can be decreased to decrease the dimensions of the end of the door frame, thereby reducing a gap between the door opening portion and the vehicle door.

According to a fourth aspect of the present invention, the engaging protrusion extends from the upper side portion, is formed on a rear surface of the bottom wall of the trim section or the outer side wall of the glass run section so as to have a U-shaped cross-section, and includes a first projection that is joined to the bottom wall of the trim section to define one of walls of the engaging protrusion, a bottom part defining a bottom thereof, and a second projection defining the other wall of the engaging protrusion. An end of the door frame is engaged in the second projection.

With the arrangement of the fourth aspect of the present invention, the engaging protrusion extends from the upper side portion, is formed on a rear surface of the bottom wall of the trim section or the outer side wall of the glass run section so as to have a U-shaped cross-section, and includes a first projection that is joined to the bottom wall of the trim section to define one of walls of the engaging protrusion, a bottom part defining a bottom thereof, and a second projection defining the other wall of the engaging protrusion, and an end of the door frame is engaged in the second projection. Therefore, the end of the door frame or the garnish is securely engaged in the interior of the engaging protrusion, whereby a gap between the bottom wall of the trim section or the outer side wall of the glass run section, which extends from the upper side portion, can be decreased.

According to a fifth aspect of the present invention, an engaging lip adapted to be engaged with the door frame is provided along an end of the side wall of the trim section, which is located on the side of the vehicle body.

With the arrangement of the fifth aspect of the present invention, since an engaging lip adapted to be engaged with the door frame is provided along an end of the side wall of the trim section, which is located on the side of the vehicle body, the engaging lip is engaged with a root of a flange of the door frame when the glass run is attached to the door frame, whereby the trim section can be prevented from coming off the flange of the door frame.

According to a sixth aspect of the present invention, the corner portion of the glass run is a rear corner portion adapted to be attached to a rear corner of the door frame of a front door, and the vertical side portion of the glass run is a rear vertical side portion adapted to be attached to a rear vertical side of the door frame of the front door.

With the arrangement of the sixth aspect of the present invention, the corner portion of the glass run is a rear corner portion adapted to be attached to a rear corner of the door frame of a front door, and the vertical side portion of the glass run is a rear vertical side portion adapted to be attached to a rear vertical side of the door frame of the front door. Therefore, there can be obtained the glass run that is prevented from coming off the rear corner of the door frame of the front door.

According to a seventh aspect of the present invention, the side wall of the trim section, which is located on the side of the glass run section, and the bottom wall of the glass run section define an integral wall.

With the arrangement of the seventh aspect of the present invention, since the side wall of the trim section, which is located on the side of the glass run section, and the bottom wall of the glass run section define an integral wall, the entire thickness of two walls can be decreased, thereby reducing the weight of the glass run. In addition, the dimensions of the glass run can be decreased.

According to an eighth aspect of the present invention, a decoration member is provided on exterior surfaces of the bottom wall of the trim section and the outer side wall of the glass run section continuously with the upper side portion.

With the arrangement of the eighth aspect of the present invention, since a decoration member is provided on exterior surfaces of the bottom wall of the trim section and the outer side wall of the glass run section continuously with the upper side portion, the appearance around the upper side of the door frame can be improved.

The corner joining section is extended from the upper side portion such that at least one part of the glass run section is cut off along with the inner seal lip of the trim section. Therefore, the bottom wall of the trim section and the outer side wall of the glass run section, which are extended from the upper side portion, can be integrally extended to an end of the upper side of the corner portion, whereby the appearance of the corner portion can be improved to its end.

An inner seal lip is formed in an area of the corner joining section, which corresponds to the cut inner seal lip of the trim section, by molding so as to be gradually tapered towards an end thereof. Therefore, after the molding of the corner portion, the inner seal lip of the corner portion can be readily removed from the mold.

Since the engaging protrusion adapted to be engaged with an end of the door frame is provided near an end of the corner engaging section, an end of the door frame or a garnish attached to the door frame can be engaged with the engaging protrusion, thereby preventing the corner portion of the glass run from coming off the corner of the door frame.

Other objects, features, and characteristics of the present invention will become apparent upon the consideration of the following description and the appended claims with reference to the accompanying drawings, all of which form a part of this specification.

### BRIEF DESCRIPTION OF THE DRAWINGS

FIG. 1 is a side view of a motor vehicle;

FIG. 2 is a cross-sectional view of a conventional glass run;

FIG. 3 is a cross-sectional view of another conventional glass run;

FIG. 4 is a front view of a glass run in one embodiment of the present invention;

FIG. 5 is a cross-sectional view of an upper side portion in one embodiment of a glass run in accordance with the present invention, which is taken along line B-B of FIG. 6;

FIG. 6 is a rear view of a corner portion in one embodiment of a glass run in accordance with the present invention;

FIG. 7 is a front view of a corner portion in one embodiment of a glass run in accordance with the present invention;

FIG. 8(a) is a plan view of an upper side portion of a glass run, of which one end defining the corner portion is cut off, in one embodiment of the present invention;

FIG. 8(b) is a rear view of an upper side portion of a glass run, of which one end defining the corner portion is cut off, in one embodiment of the present invention;

FIG. 9(a) is a cross-sectional view of an upper side portion of a glass run, of which one end defining the corner portion is cut off, in one embodiment of the present invention, which is taken along line C-C of FIG. 8(b);

FIG. 9(b) is a cross-sectional view of an upper side portion of a glass run, of which one end defining the corner portion is cut off, in one embodiment of the present invention, which is taken along line D-D of FIG. 8(b); and

FIG. 10 is a cross-sectional view of a corner engaging section in a corner portion in one embodiment of a glass run in accordance with the present invention, which is taken along line A-A of FIG. 6.

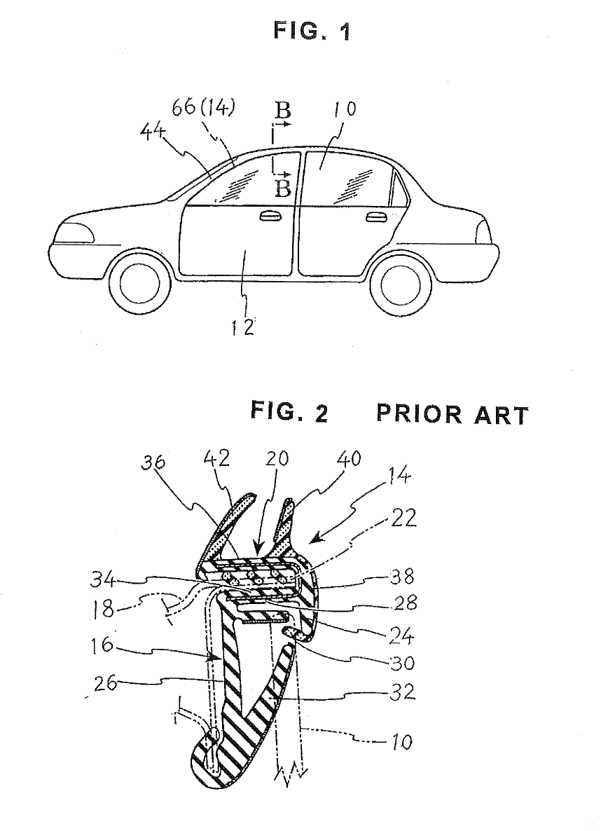

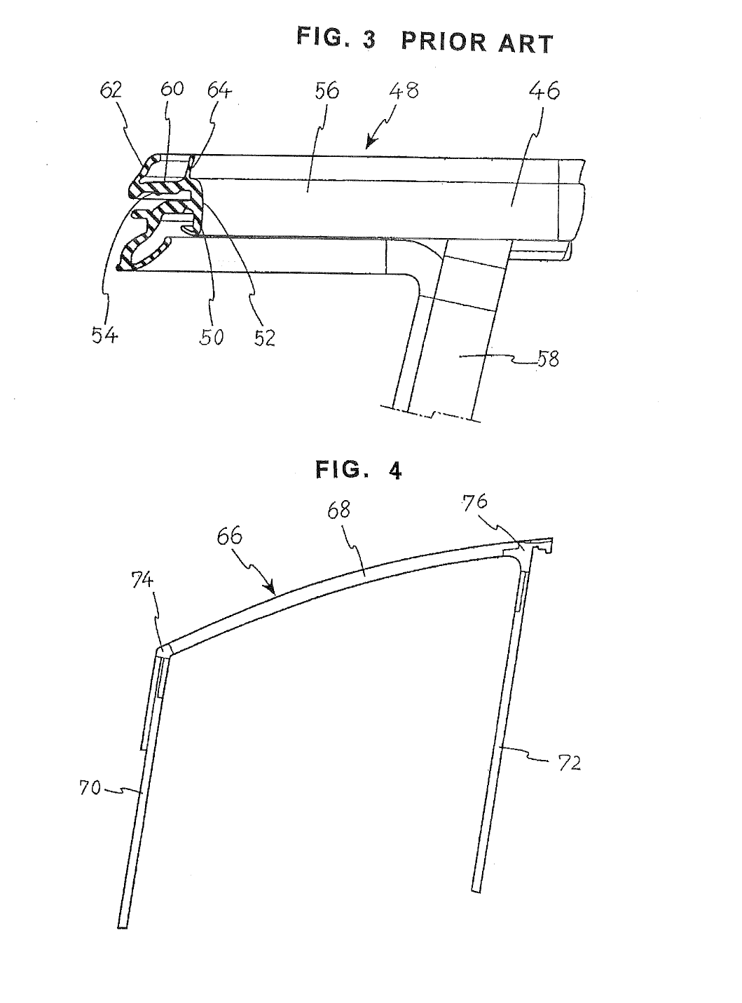

### DETAILED DESCRIPTION OF THE PREFERRED EMBODIMENTS

One embodiment of the present invention will be explained with reference to FIG. 1, and FIG. 4 through FIG. 10.

FIG. 1 is a side view of a motor vehicle. As shown in FIG. 1, a glass run 66 in accordance with the present invention is used in a sashless door-type motor vehicle. An exterior part of the door sash is removed above the door belt line of a front door and a rear door of the motor vehicle, and only door glasses 10 are visible in an exterior side of the motor vehicle. The door glasses 10 slide inwardly and outwardly of the front door and the rear door of the motor vehicle.

As shown in FIG. 4, the glass run 66 includes an upper side portion 68 for attachment to an upper side of a door frame 18, a front vertical side portion 70 for attachment to a front vertical side of the door frame 18, a rear vertical side portion 72 for attachment to a rear vertical side of the door frame 18, a front corner portion 74 adapted to join the upper side portion 68 to the front vertical side portion 70 for attachment to a front corner of the door fame 18, and a rear corner portion 76 adapted to join the upper side portion 68 to the rear vertical side portion 72 for attachment to a rear corner of the door fame 18. With this arrangement, not only the upper side of the door frame 18 but also vertical sides of the door frame 18, which are along vertical edges of the door glass 10, are held and sealed with the glass run 66. In addition, the corners of the door frame 18 can be securely sealed with the front corner portion 74 and the rear corner portion 76.

The upper side portion 68, the front vertical side portion 70 and the rear vertical side portion 72 are respectively formed by extrusion, and are respectively cut to a predetermined length. The front corner portion 74 and the rear corner portion 76 are formed by molding. Upon molding, the front corner portion 74 joins the upper side portion 68 to the front vertical side portion 70, whereas the rear corner portion 76 joins the upper side portion 68 to the rear vertical side portion 72, by vulcanized adhesion.

The present invention relates to the glass run 66 adapted to be attached to the door frame 18, and more particularly, to a part of the rear corner portion 76 on the side of the upper side portion 68. The present invention will be explained with reference to the rear corner portion 76 of a front door, and particularly, to the part of the rear corner portion 76 on the side of the upper side portion 68, but can be also used in a front corner of a rear door.

First, the configuration of the upper side portion 68 will be explained, and next, the configurations of the rear corner portion 76 along with a cut area of the upper side portion 68 will be explained.

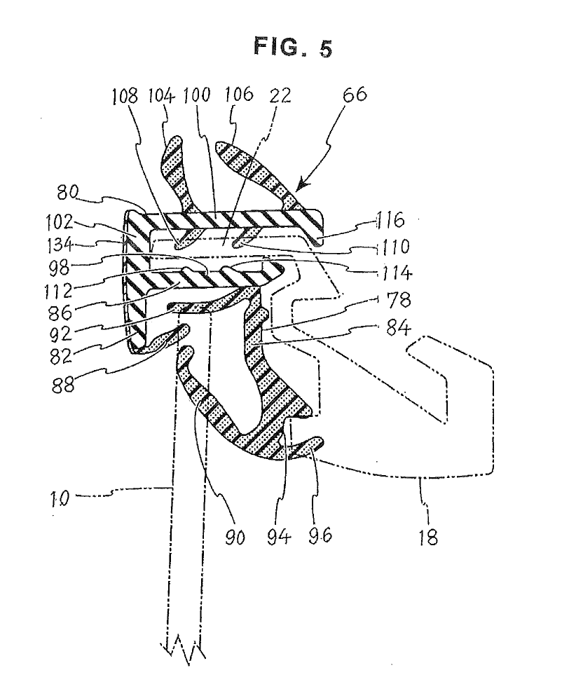

As shown in FIG. 5, the upper side portion 68 of the glass run 66 includes a glass run section 78 adapted to be attached along an inner periphery of the door frame 18 and a trim section 80 adapted to be attached to the flange 22 that is provided along an end of the door frame 18. First, configurations of the glass run section 78 and the trim section 80 will be respectively explained.

The glass run section 78 has a main body with a generally U-shaped cross-section, which includes an outer side wall 82, an inner side wall 84 and a bottom wall 86. An outer seal lip 88 and an inner seal lip 90 respectively extend from ends of the outer side wall 82 and the inner side wall 84 obliquely in an interior space of the main body. Therefore, an end edge of the door glass 10 slides in the interior space of the main body of the glass run section 78, which includes the outer side wall 82, the inner side wall 84 and the bottom wall 86, thereby holding and sealing the door glass 10.

The glass run section 78 is composed of a soft material. It is preferable to use a thermoplastic olefin elastomer as the soft material. Since the soft material is used, the outer seal lip 88 and the inner seal lip 90 can flexibly bend. When the door glass 10 is raised, they can securely contact the end edge of the door glass 10 to provide a seal between the door glass 10 and the door frame 18.

In the case where the thermoplastic olefin elastomer is used as the glass run section 78, and an olefin synthetic resin is used as the trim section 80, they are readily formed integrally, and recycling of the glass run is facilitated. Alternatively, thermoplastic olefin elastomer foams can be used.

It is preferable to increase the width and the thickness of the inner side wall 84 and the inner seal lip 90, as compared with those of the outer side wall 82 and the outer seal lip 88. In this case, when the door glass 10 is raised and inserted in the interior space of the glass run 66, the door glass 10 can be shifted outwardly to reduce level difference in the exterior surface of the door 12, thereby improving the appearance therearound, and restraining the generation of wind noises.

It is preferable to apply a low sliding member to surfaces of the outer seal lip 88 and the inner seal lip 90, which are adapted to contact the door glass 10. Examples of the low sliding member include TPV (olefin thermoplastic vulcanized elastomer) exhibiting low sliding properties, which is formed into a thin film thereon, or silicon paints, urethane paints, etc. are painted thereon. With this arrangement, the door glass can be raised and lowered smoothly, and the generation of wind noises can be prevented.

A bottom lip 92 can be formed on an interior side of the bottom wall 86 so as to project from a joint between the inner side wall 84 and the bottom wall 86. When the door glass 10 is raised, the bottom lip 92 contacts an upper end edge of the door glass 10 to absorb shocks against the bottom wall 86. It is preferable to apply a low sliding member to surfaces of the bottom lip 92, too.

An attaching recess 94 is provided in an exterior surface of the inner side wall 84. When the glass run 66 is attached to the door frame 18, a protrusion provided in the door frame 18 is engaged with the attaching recess 94 to hold the inner side wall 84 of the glass run section 78.

An inner cover lip 96 is formed along the end of the inner side wall 84 so as to extend outwardly of the interior space of the main body of the glass run section 78 and contact the protrusion of the door frame 18.

Next, the trim section 80 will be explained. As shown in FIG. 5, the trim section 80 has a generally U-shaped cross-section, and includes a side wall 98 adapted to be joined to the bottom wall 86, a side wall 100 for facing the door opening portion 44, and a bottom wall 102. The flange 22 of the door frame 18 is inserted into an interior space of the trim section 80, and held therein, whereby the glass run 66 is attached to the door frame 18.

An outer seal lip 104 and an inner seal lip 106 project from an exterior surface of the side wall 100 of the trim section 80, which faces the door opening portion 44. When the door 12 is closed, the outer seal lip 104 and the inner seal lip 106 contact the door opening portion 44 to provide a double seal between the door opening portion 44 and the door frame 18.

A first holding lip 108 and a second holding lip 110 are formed in an interior surface of the side wall 100 of the trim section 80, whereas a first holding ridge 112 and a second holding ridge 114 are formed in an interior surface of the side wall 98 of the trim section 80. As shown in FIG. 5, when the flange 22 of the door frame 18 is inserted into the interior space of the trim section 80, one side surface of the flange 22 can be held with the first holding lip 108 and the second holding lip 110, whereas the other side surface of the flange 22 can be held with the first holding ridge 112 and the second holding ridge 114.

An engaging lip 116 projects from an end of the side wall 100 of the trim section 80 inwardly. As shown in FIG. 5, when the flange 22 of the door frame 18 is inserted into the interior space of the trim section 80, the engaging lip 116 contacts a bending base of the flange 22 to prevent the trim section 80 from coming off the flange 22.

The trim section 80 is arranged such that the side wall 98 on the side of the glass run section 78, the side wall 100 for facing the door opening portion 44, the bottom wall 102, the first holding ridge 112 and the second holding ridge 114 are composed of a hard material, whereas the outer seal lip 104, the inner seal lip 106, the first holding lip 108 and the second holding lip 110 are composed of a soft material. The trim section 80 is formed simultaneously with the glass run section 78 by extruding the hard material and the soft material.

As a result, the main body of the trim section 80 exhibits high rigidity so as to hold the flange 22 securely. The outer seal lip 104 and the inner seal lip 106 flexibly bend to conform to the configuration of the door opening portion 44 and contact the same to provide a seal thereagainst. And the first holding lip 108 and the second holding lip 110 flexibly contact the flange 22 to provide a seal thereagainst.

Next, the rear corner portion 76 will be explained.

The rear corner portion 76 includes a corner joining section 120 adapted to join the upper side portion 68 to the rear vertical side portion 72, and a corner engaging section 122 adapted to extend from the corner joining section 120 rearwardly for engagement with a rear end of the door frame 18. Therefore, upon molding the rear corner portion 76, the upper side portion 68 and the rear vertical side portion 72 are simultaneously joined to each other through vulcanization with the corner joining section 120. In addition, the corner engaging section 122 can attach the rear corner portion 76 to the rear end of the door frame 18, thereby preventing the rear corner portion 76 from coming off the door frame 18.

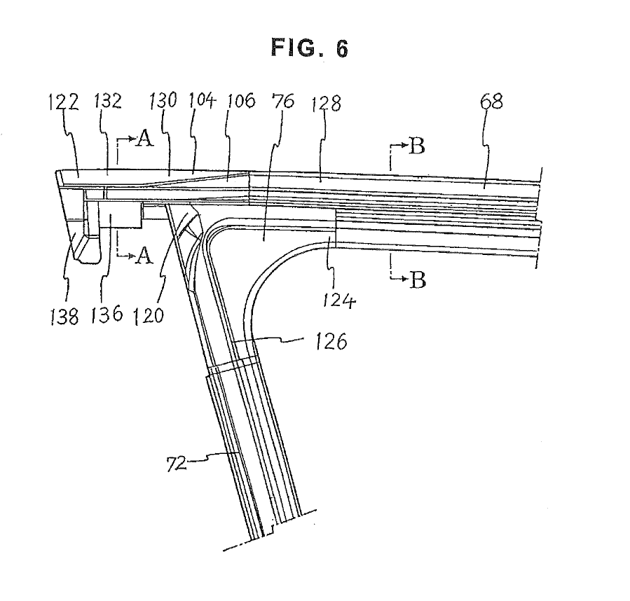

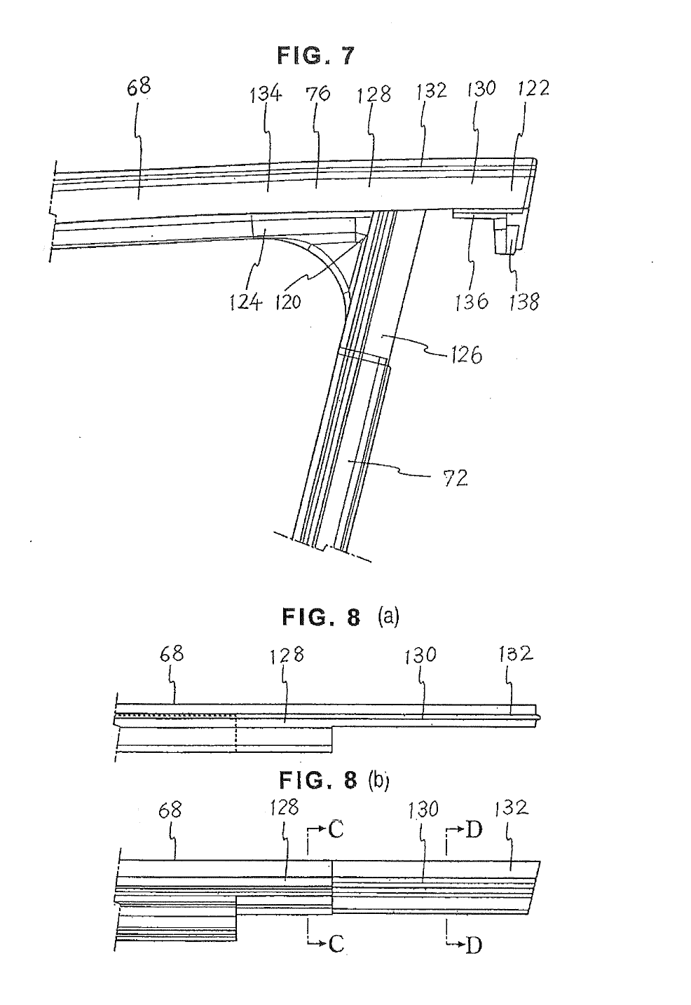

As shown in FIGS. 6 and 7, the corner joining section 120 joins the upper side portion 68 with an upper joint 124, and joins the rear vertical portion 72 with a vertical joint 126.

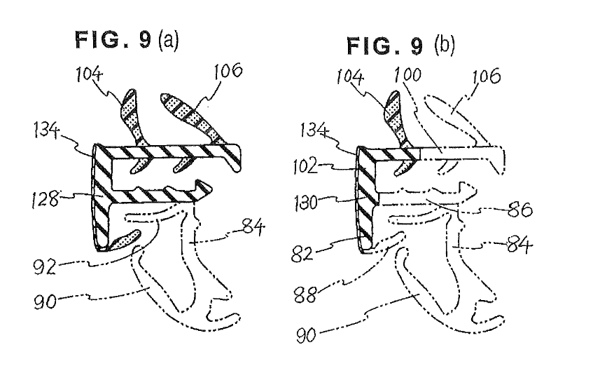

As shown in FIGS. 8(a), 8(b), 9(a) and 9(b), the upper side portion 68 is partly cut off at the upper joint 124, and is extended towards an end of the corner engaging section 122, thereby partly defining the rear corner portion 76. Areas designated with two-dot chain lines in FIGS. 9(a) and 9(b) are cut off.

As shown in FIG. 9(a), in a first cut part 128 of the rear corner portion 76, which is near the upper side portion 68, the inner side wall 84, the inner seal lip 90 and the bottom lip 92 of the glass run section 78 are cut off.

And, as shown in FIG. 9(b), in a second cut part 130 of the rear corner portion 76, which is on a rear side of the first cut part 128, the bottom wall 86 and the inner seal lip 88 of the glass run section 78 along with a half of the side wall 100 and the inner seal lip 106 of the trim portion 80 are further cut off

Therefore, the bottom wall 102 of the trim section 80 and the outer side wall 82 of the glass run section 78, which are integrally provided with each other, can be extended to a rear end of the upper side of the rear corner portion 76 via an upper side extending portion 132. There is no boundary line between exterior surfaces of the bottom wall 102 of the trim section 80 and the outer side wall 82 of the glass run section 78, thereby providing an integral design surface, and consequently, an external appearance of the rear corner portion 76 can be improved to its rear end.

Furthermore, where a decoration molding 134 as a decoration member is bonded to the exterior surfaces of the bottom wall 102 of the trim section 80 and the outer side wall 82 of the glass run section 78, the appearance around the upper side of the door frame 18 can be improved.

In addition, since the glass run section 78 is cut off, the vertical joint 126 of the corner joining section 120 can define a glass run section conforming to the cross-section of the rear vertical portion 72, so as to be joined thereto.

As shown in FIG. 6, in the second cut part 130 of the rear corner portion 76, the inner seal lip 106 of the trim portion 80 is formed by molding in a cut area of the corner joining section 120 so as to be tapered toward an end thereof. As a result, when the rear corner portion 76 thus molded is removed from the mold, the inner seal lip 106 of the trim portion 80 is prevented from being caught in the mold even if the outer seal lip 104 exists, and consequently, the rear corner portion 76 can be readily removed from the mold.

And as shown in FIG. 6 and FIG. 7, the corner engaging section 122 is provided in the rear corner portion 76 rearwardly of the corner joining section 120. The corner engaging section 122 is provided in the second cut part 130 of the upper side extending portion 132 that extends from the upper side portion 68. An engaging protrusion 136 and an engaging end 138 adapted to be engaged with an end of the door frame 18 are provided near the rear end of the corner engaging section 122. The engaging end 138 contacts a rear side end of the door frame 18.

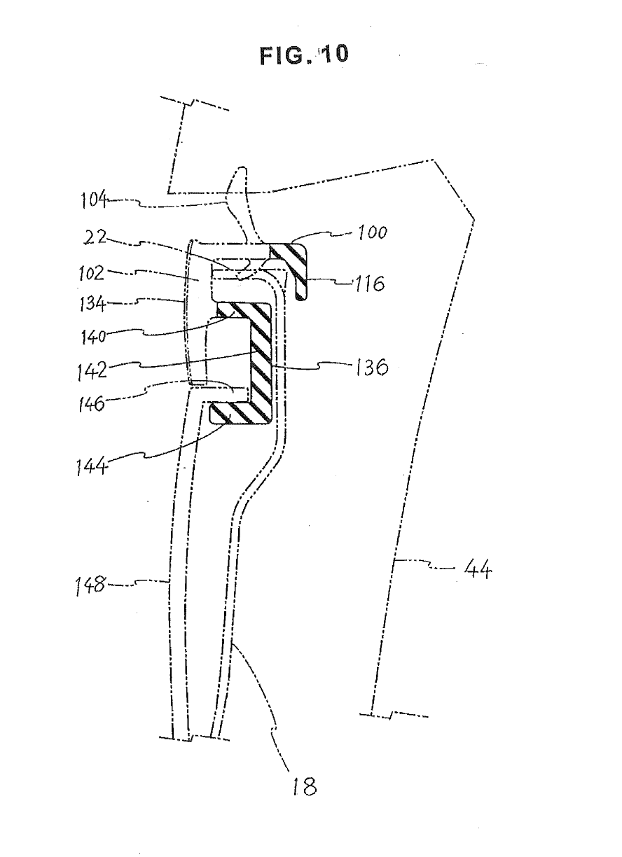

As shown in FIG. 10, the engaging protrusion 136 is formed on a rear surface of the bottom wall 102 of the trim section 80 so as to extend from the upper side portion 68 with a U-shaped cross-section. The engaging protrusion 136 has a first projection 140 that is joined to the bottom wall 102, thereby defining one of walls of the U-shaped cross-section, and a bottom part 142 as a bottom thereof, and a second projection 144 as the other wall thereof. An end 146 of a garnish 148 secured to the door frame 18 is engaged with the second projection 144. With this arrangement, the end of the door frame 18 or the end of the garnish 148 can be securely engaged in the U-shaped interior space of the engaging protrusion 136, thereby preventing the rear corner portion 76 of the glass run 66 from coming off the corner of the door frame 18. As a result, the sealing properties can be achieved. In addition, gaps between the door frame 18 or the garnish 148, and the end of the glass run 66 can be reduced.

On the other hand, in the front corner part 74, an engaging lip is formed at an end of the side wall 100 of the trim section 80 by molding. The engaging lip can be engaged in an end of the flange 22, thereby preventing the corner engaging section 122 of the glass run 66 from coming off the door frame 18.

Upon producing the glass run 66, a thermoplastic elastomer or a soft synthetic resin is used as the soft members, which are composed of a solid material or a sponge material. Examples of the thermoplastic elastomer include an olefin elastomer, and examples of the soft synthetic resin include a soft vinyl chloride. And an olefin synthetic resin such as polypropylene resin, polyethylene resin, etc. is used as the hard members of the glass run 66.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A glass run adapted to be attached to a door frame of a vehicle door for providing a seal between a door opening portion and the vehicle door, comprising:
an upper side portion formed by extrusion and adapted to be attached to an upper side of the door frame, a vertical side portion formed by extrusion and adapted to be attached to a vertical side of the door frame, and a corner portion formed by molding to join said upper side portion and said vertical side portion to each other, and adapted to be attached to a corner of the door frame, wherein
said upper side portion includes a glass run section adapted to seal a door glass, and a trim section adapted to be attached to the door frame, said glass run section and said trim section being integrally formed with each other,
said glass run section includes an outer side wall, an inner side wall and a bottom wall with a generally U-shaped cross-section, an outer seal lip and an inner seal lip respectively extend from ends of said outer side wall and said inner side wall obliquely in an interior space of said glass run section with a generally U-shaped cross-section,
said trim section includes one side wall located on the side of said glass run section, the other side wall located on the side of a vehicle body, and a bottom wall with a generally U-shaped cross-section, an outer seal lip and an inner seal lip are formed in said the other side wall located on the side of the vehicle body for contacting the door opening portion,
said corner portion includes a corner joining section adapted to join said upper side portion to said vertical side portion, and a corner engaging section extending from said corner joining section for engagement with the door frame, said corner joining section extends from said upper side portion such that at least one part of said glass run section is cut off along with said inner seal lip of said trim section, an inner seal lip is formed in an area corresponding to said cut inner seal lip by molding so as to be gradually tapered towards an end thereof, and an engaging protrusion adapted to be engaged with an end of the door frame is provided near an end of said corner engaging section.

2. A glass run as claimed in claim 1, wherein said engaging protrusion is engaged with an end of a garnish attached to the vertical side of the door frame.

3. A glass run as claimed in claim 1, wherein said corner engaging section extends from said upper side portion of the door frame such that said inner side wall, said bottom wall and said inner seal lip of said glass run section are cut off along with a half of said one side wall of said trim section, which is located on the side of the vehicle body, and said inner seal lip of said trim section.

4. A glass run as claimed in claim 1, wherein said engaging protrusion extends from said upper side portion, is formed on a rear surface of one of said bottom wall of said trim section and said outer side wall of said glass run section so as to have a U-shaped cross-section, and includes a first projection that is joined to said bottom wall of said trim section to define one of walls of said engaging protrusion, a bottom part defining a bottom thereof, and a second projection defining the other wall of said engaging protrusion, and an end of the door frame is engaged with said second projection.

5. A glass run as claimed in claim 1, wherein an engaging lip adapted to be engaged with the door frame is provided along an end of said side wall of said trim section, which is located on the side of the vehicle body.

6. A glass run as claimed in claim 1, wherein said corner portion is a rear corner portion adapted to be attached to a rear corner of the door frame of a front door, and said vertical side portion is a rear vertical side portion adapted to be attached to a rear vertical side of the door frame of the front door.

7. A glass run as claimed in claim 1, wherein said side wall of said trim section, which is located on the side of said glass run section, and said bottom wall of said glass run section define an integral wall.

8. A glass run as claimed in claim 1, wherein a decoration member is provided on exterior surfaces of said bottom wall of said trim section and said outer side wall of said glass run section continuously with said upper side portion.
